(19) United States
(12) Patent Application Publication
(10) Pub. No.: US 2026/0261989 A1
(43) Pub. Date: Sep. 3, 2026

(54) Multi-Band Radio Dynamic Power Configuration

(71) Applicant: Telefonaktiebolaget LM Ericsson (PUBL), Stockholm (SE)

(72) Inventors: Kresimir ILIC, Zagreb (HR); Konrad LIEDTKE, Krakow (PL); Denis COLIC, Osijek (HR); Simon RICHARDSON, Sligo (IE)

(21) Appl. No.: 19/490,005

(22) PCT Filed: Jun. 7, 2023
(86) PCT No.: PCT/IB2023/055893

§ 371 Date: Dec. 4, 2025

(51) Int. Cl. H04W 52/34; H04W 52/14

(52) U.S. Cl. CPC H04W 52/346; H04W 52/143

(57) ABSTRACT

A method performed by a network node for dynamic power configuration in multi-band radios is presented. The network node has a multi-band radio. The method comprises detecting a change in a first power configuration at a first frequency band of the multi-band radio. The method further comprises automatically reconfiguring a power configuration at one or more other frequency bands until an effect of the change in the first power configuration in a total power utilization is compensated.

### TECHNICAL FIELD

Embodiments of the present disclosure are directed to wireless communications and, more particularly, to dynamic power configuration in multi-band radios.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

### Citizens Broadband Radio Service (CBRS)

CBRS is a dedicated spectrum from 3.55 GHz to 3.7 GHZ, which represents approximately 16% expansion of licensed spectrum below 4 GHz in the United States. The Third Generation Partnership Project (3GPP) has defined B48 long term evolution (LTE) and n48 new radio (NR) for CBRS as time-division duplexing (TDD) band and the Federal Communications Commission (FCC) has approved it for shared commercial use with the incumbent military radars and satellite ground stations.

In recent years, CBRS has been the catalyst for innovation to expand cellular usage beyond enhanced mobile broadband (eMBB) in the United States. Combined with the commercial rollout of priority access licenses (PAL), CBRS network deployments are rapidly gaining momentum and proliferating across thousands of sites across the country, which enable use cases such as fixed wireless access (FWA), mobile network densification, and private cellular networks.

The FCC approved this spectrum for shared commercial use with the incumbent military radars and satellite ground stations.

The three-tier sharing paradigm coordinates the spectrum access usage on the CBRS band. The three-tier sharing paradigm includes the following tiers.
Tier #1 is for incumbent access. This is the highest priority tier, reserved for federal incumbent users, such as military, fixed satellite service, or wireless internet service providers (ISPs). This tier receives interference protection from all lower tier users.
Tier #2 is for priority access licenses (PAL). This is the second priority tier, allocated on a county basis. PAL users are protected from interference of other PAL and lower tier users.
Tier #3 is for general authorized access (GAA). This is the lowest priority tier, open for all users, without license. This tier receives no interference protection from other users.

Each tier accepts interference from tiers above and is protected from tiers below. When detecting the interference from higher priority tier users, the spectrum access system (SAS) instructs the CBSD to cease transmission or move to another unoccupied frequency range. The SAS may allocate unused PAL spectrum to GAA users on a dynamic basis.

### Multi-Band Technology

Multi-band technology refers to techniques that enable radio base station equipment to operate in multiple bands concurrently. Most radio access networks today employ multiple bands including low frequency bands, e.g. sub- 1 GHz, mid frequency bands, e.g. 1-6 GHz and millimeter wave (mmW) bands. Conventionally, multi-band operation is supported by multiple remote radio units (RRU) deployed on radio towers or masts. This type of deployment leads to crowded sites and heavily loaded towers, making further network expansion difficult. This issue is worsened by fifth generation (5G) massive multiple-input-multiple-output (MIMO) radios, which have larger size, weight and wind load than RRUs due to the integrated antenna panels. Therefore, future capacity expansion of radio access networks necessitates the aggregation of tower equipment, by means of, e.g., multi-band RRU, multi-band passive antennas, and multi-band advanced antenna systems (AAS).

The hardware and algorithms located further away from an antenna are less dependent on the operating frequency. Therefore, the baseband hardware and software are largely frequency agnostic, although certain multi-band capabilities do impact baseband software. For example, dynamic power sharing may require a hardware-aware scheduler to maximize its potential. The first generation of multi-band radios, with shared mechanical enclosures, direct current (DC) power supplies, etc., but with separate power amplifiers for different frequency bands, are referred to as “multisingle-band” radios. In contrast, the latter type of radios, consisting of concurrent wideband or multi-band power amplifiers, are referred to as “true multi-band” radios. The distinctive feature enabled by a true multi-band radio is “dynamic power sharing”, which enables the full power capability to be dynamically allocated to any of the operating bands, according to instantaneous traffic needs. Dynamic power sharing can be used to enhance network performance by temporarily allocating unused power capability from one band to boost the power in another band.

### Coexistence Between CBRS and Multi-Band Technology

There exist certain challenges with coexistence between CBRS and multi-band technology. In one example, a domain coordinator/domain proxy supports power reconfiguration on a radio access network (RAN) based on a request from SAS. The domain coordinator shall maximize power from available authorized grants and power from the SAS. For multi-band radios containing CBRS band (B48 or n48), dynamic power reconfiguration triggered by SAS authorized grant and power results in dynamic power reconfiguration on RAN on CBRS band. However, power reconfiguration on other bands on the multi-band radio is not supported. Due to the dynamic nature of CBRS spectrum assignment, allocated power to a certain CBSD channel is a result of external spectrum allocation service and is not under direct control of network operator. CBSD corresponds to the CBRS (B48 or n48) part of a multi-band radio.

An operator initially configures the CBSD using corresponding configuration parameters, including initial power configuration, to use available CBRS channels. The operator also initially configures the power configuration to use available non-CBRS bands on the multi-band radio. Full power capability of the multi-band radio is a result of optimal initial configuration for all bands on the multi-band radio.

For multi-band radios containing CBRS band (B48 or n48) dynamic power reconfiguration triggered by SAS results in dynamic power reconfiguration on RAN on CBRS band, which may negatively affect full power capability of the multi-band radio. Thus, the negative affect on the full power capability of multi-band radio may include, either breaching of total power capability if the CBRS band power increases by SAS, or decrease in total power capability utilization if CBRS band power decreases by SAS. Examples of problems occurring due to the dynamic power reconfiguration on CBRS band are described below.

FIGS. 1 and 2 illustrate a problem related to shared power budget between static and dynamic bands in multi-band radios. For example, one problem is that the initial power configuration on B77D remains static, while the initial power configuration on B48 may change dynamically by SAS. If SAS increases B48 power level, the total maximum power level limit may be breached. If SAS decreases B48 power level, the total maximum power level limit may not be fully utilized.

FIG. 1 illustrates a problem in where B48 power change breaches max power limit. Above example shows the situation in which power increase on B48 leads to the undesired state in which total power capability does not allow power increase on B48 due to the static nature of power configuration on B77.

FIG. 2 illustrates a problem where B48 power change decreases total power utilization. In the illustrated example, power decrease on B48 leads to the undesired state in which total power capability is not fully utilized due to the static nature of power configuration on B77. It is important to notice that the dynamic change of power configuration on B48 is not under the operator's control, but under control of external service provided by SAS. Change of power configuration on B77 in the examples above are under operator's control. Changes of configuration are administered using a network manager component, which is under operator's control, but the changes are the result of operator's manual intervention, which makes B77 power configuration static.

### Change Management of Power Configurations on Multi-band Radios

The same or similar problems as described above may also occur when the power change on one of the bands on a multi-band radio occurs as a result of manual power re-configuration on non-CBRS bands done by the operator, which would result in a need to conduct the power reconfiguration on all available bands on that particular multi-band radio, and increased downtime. Prior implementations do not provide mechanisms for the operator to dynamically configure power on all bands on multi-band radios, triggered either by a dynamic change on the CBRS band or by a manual change on any of available bands on a multi-band radio.

### SUMMARY

As described above, certain challenges currently exist with power configuration for multi-band radios. Certain aspects of the present disclosure and their embodiments provide solutions to these and other challenges. For example, some embodiments enable dynamic power reconfiguration on all available bands on a multi-band radio, triggered by either dynamic changes from an external service not under the operator's control, such as Spectrum Access System (SAS) for Citizens Broadband Radio Service (CBRS) band or by manual re-configurations on other bands.

Particular embodiments enable full control over possible scenarios/use cases which avoid the need for operator control and manual intervention. Some embodiments avoid technical problems such as alarming conditions on the radios. Some embodiments avoid downtime due to the reconfiguration and avoid the underutilization of overall power capability of multi-band radios.

According to some embodiments, a method is performed by a network node for dynamic power configuration in multi-band radios. The network node has a multi-band radio. The method comprises detecting a change in a first power configuration at a first frequency band of the multi-band radio. The method further comprises automatically reconfiguring a power configuration at one or more other frequency bands until an effect of the change in the first power configuration in a total power utilization is compensated.

In particular embodiments, the change is a power increase in the first power configuration, and automatically reconfiguring the power configuration at the one or more other frequency bands comprises decreasing a second power configuration at the one or more other frequency bands. In particular embodiments, the decrease in the second power configuration is evenly distributed between the one or more other frequency bands.

In particular embodiments, the change is a power decrease in the first power configuration, and automatically reconfiguring the power configuration at the one or more other frequency bands comprises increasing a second power configuration at the one or more other frequency bands. In particular embodiments, the increase in the second power configuration is evenly distributed between the one or more other frequency bands.

In particular embodiments, automatically reconfiguring the power configuration at the one or more other frequency bands is according to a set of parameters. In particular embodiments, the set of parameters comprises a first parameter that indicates adjusting power levels at the one or more other frequency bands should not exceed a minimum boundary. In particular embodiments, the set of parameters further comprises a second parameter that indicates adjusting power levels at the one or more other frequency bands should not exceed a maximum boundary.

In particular embodiments, the set of parameters indicates a priority for each of the one or more other frequency bands, such that less power level decrease is applied to a frequency band with a high priority. In particular embodiments, the first frequency band is controlled by a first operating entity and the one or more other frequency bands are controlled by a second operating entity. In particular embodiments, the first operating entity comprises a spectrum access system (SAS). In particular embodiments, detecting the change in the first power configuration at the first frequency band comprises receiving a grant from the SAS with a changed power value. In particular embodiments, the first operating entity comprises a network operator. In particular embodiments, detecting the change in the first power configuration at the first frequency band comprises detecting a manual power reconfiguration.

According to some embodiments, a network node comprises processing circuitry operable to perform any of the network node methods described above.

Also disclosed is a computer program product comprising a non-transitory computer readable medium storing computer readable program code, the computer readable program code operable, when executed by processing circuitry to perform any of the methods performed by network node described above.

Technical advantages of particular embodiments are directed to applying new standardized parameters used in initial power configuration of the multi-band radios to support the solution respecting the objectives described herein. Such technical advantages include the following: (a) full control over possible scenarios/use cases; (b) avoid the need for operator control and manual interventions; (c) avoid technical problems such as alarming conditions on the radios; (d) avoid downtime due to the reconfiguration; and/or (e) avoid the underutilization of overall power capability of multi-band radios.

Particular embodiments provide certain dynamic power configuration advantages, including: (a) increasing the power higher than a maximum power may be prevented; (b) decreasing power lower than a minimum power may be prevented; (c) not using the total maximum power budget may be prevented; (d) no need for alarms for boundary breaches; (e) no need for manual intervention for alarms; (f) no need for manual adaptation due to the dynamic nature of B48 band changes by SAS; (g) immediate automatic system response to the B48 power changes by SA; (h) flexible definition of priorities between bands and power boundaries (min, max); (i) and/or competitive edge functionality of network manager and dual connectivity (DC).

Particular embodiments provide technical advantages to the uniform distribution approach, including obviating the need for defining for priorities for power redistribution and treating all bands affected by the change equally, but only when this is in accordance with the operator's policy and network optimization.

Particular embodiments are configured to set the same or similar priorities for the affected bands results effectively in uniform distribution. Therefore, in such embodiments, the power reconfiguration method may be universally applied to all operator's policies. Particular embodiments are configured to define dynamic power redistribution policy, i.e. priorities to better utilize the dynamic changes in accordance with the network optimization plans.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates a problem where B48 power change breaches max power limit;

FIG. 2 illustrates a problem where B48 power change decreases total power utilization;

FIG. 3 illustrates an example solution to the problem described in FIG. 1;

FIG. 4 illustrates an example solution to the problem described in FIG. 2;

FIG. 5 illustrates an example where B48 plus more than one band share total power budget;

FIG. 6 illustrates an example where B48 power increase triggers dynamic decrease of other bands power configuration;

FIG. 7 illustrates an example where B48 power decrease triggers dynamic increase of other bands power configuration;

FIG. 8 illustrates an example with B48 power increase where boundaries and priorities are defined on other bands;

FIG. 9 illustrates an example with B48 power decrease where boundaries and priorities are defined on other bands;

FIG. 10 illustrates a CBRS architecture, according to certain embodiments;

FIG. 11 is an example flowchart illustrating a method for managing distribution of dynamic power configuration on multi-band radios;

FIG. 12 is a block diagram illustrating an example wireless network;

FIG. 13 illustrates an example user equipment, according to certain embodiments;

FIG. 14 illustrates an example virtualization environment, according to certain embodiments;

FIG. 15 illustrates an example telecommunication network connected via an intermediate network to a host computer, according to certain embodiments;

FIG. 16 illustrates an example host computer communicating via a base station with a user equipment over a partially wireless connection, according to certain embodiments;

FIG. 17 is a flowchart illustrating a method implemented, according to certain embodiments;

FIG. 18 is a flowchart illustrating a method implemented in a communication system, according to certain embodiments;

FIG. 19 is a flowchart illustrating a method implemented in a communication system, according to certain embodiments;

FIG. 20 is a flowchart illustrating a method implemented in a communication system, according to certain embodiments;

FIG. 21 is a flowchart illustrating an example method in a network node, according to certain embodiments; and

FIG. 22 illustrates a schematic block diagram of a network node in a wireless network, according to certain embodiments.

### DETAILED DESCRIPTION

Particular embodiments described herein provide systems and methods for dynamic power reconfiguration for multi-band radios. Citizens Broadband Radio Service (CBRS) provides managed dynamic configuration of power on multi-band radios. For CBRS band presence on a multi-band radio, CBRS band power parameters may be changed dynamically by an external service, i.e., Spectrum Access System (SAS). Particular embodiments dynamically adapt power related parameters for all bands on a multi-band radio, universally for all bands, even when CBRS band is not present, but the change of overall power budget on a multi-band radio has been triggered by another band change.

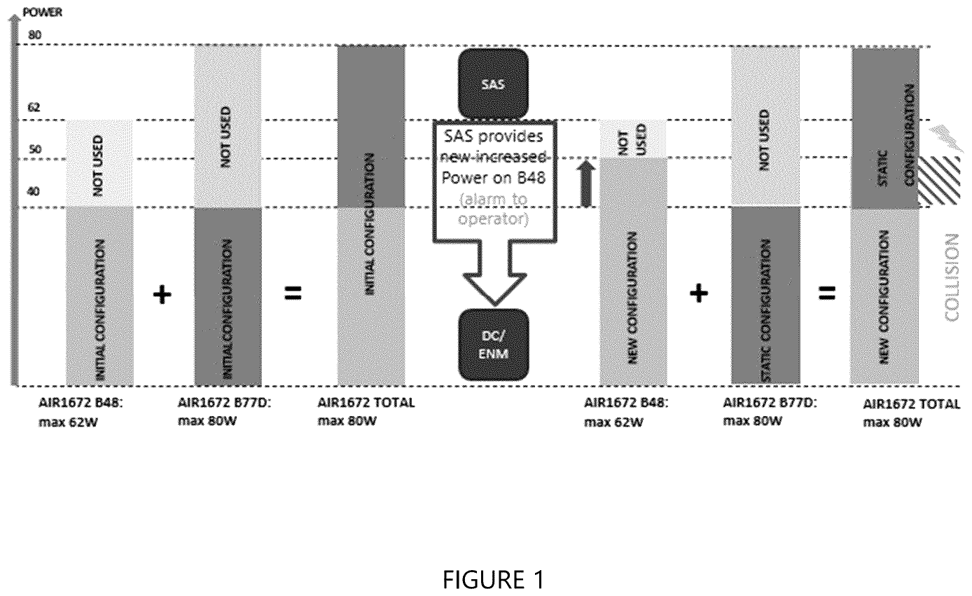

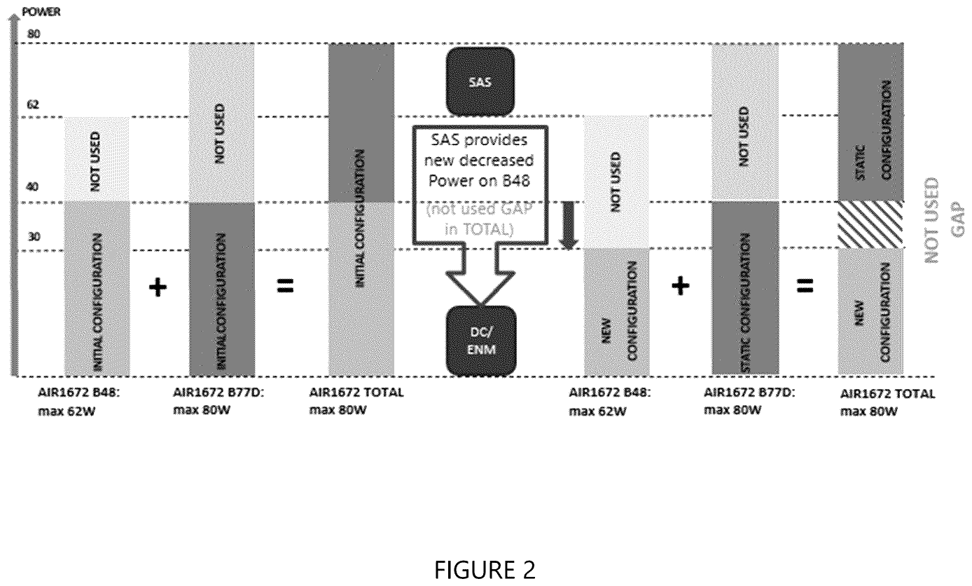

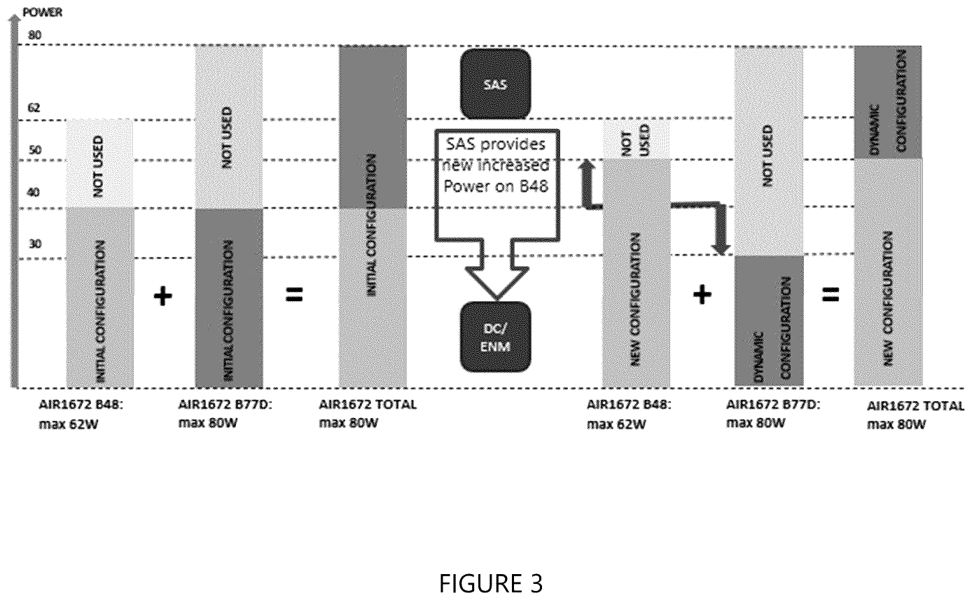

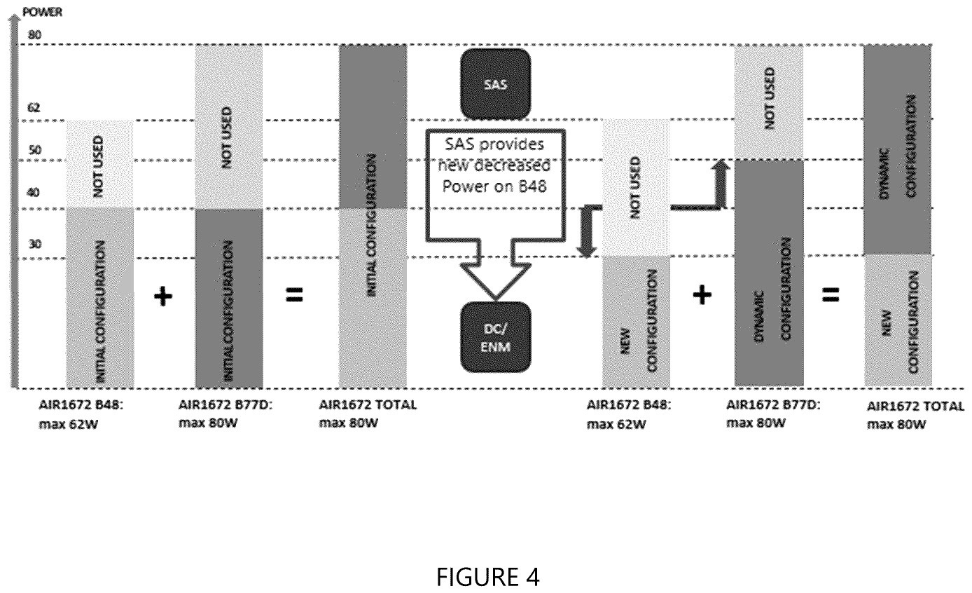

Particular embodiments provide example solutions to the problems described with respect to FIGS. 1-2. Such example solutions are described with respect to FIGS. 3 and 4.

FIG. 3 illustrates an example solution to the problem described in FIG. 1 (i.e., B48 power change breaches max power limit). FIG. 4 illustrates the situation in which power increase on B48 leads to the dynamic power reconfiguration on B77. Breaching of total power capability is prevented, as well as an alarm situation that would require operator's manual intervention to resolve the alarm.

FIG. 4 illustrates an example solution to the problem described in FIG. 2 (i.e., B48 power change decreases total power utilization). FIG. 4 illustrates the situation in which power decrease on B48 leads to the dynamic power reconfiguration on B77. Underutilization of total power capability is prevented, as well as the need to conduct manual intervention to optimize the power utilization and the distribution among bands.

### Power Distribution Between More Than Two Bands on a Multi-Band Radio

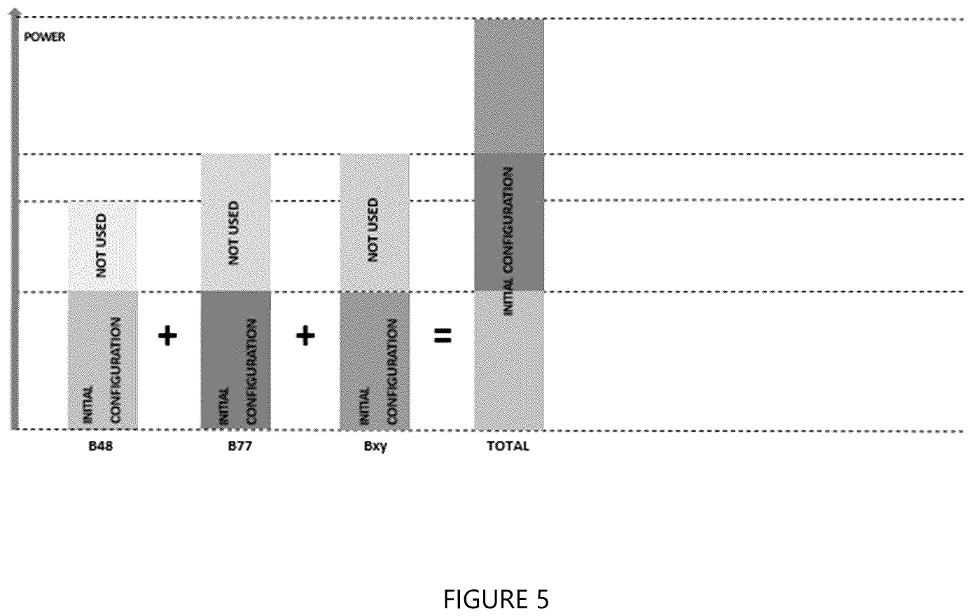

The example embodiments described above use the example of two bands that share total power capability, however, certain embodiments may be applicable universally, i.e. to the multi-band radio with shared power capability between more than two bands. More bands means more complexity in power distribution when a change is triggered by one of bands. Initial configuration implies that the total power capability is used entirely and distributed optimally between the available bands. Example solutions provided by certain embodiments are described below and illustrated in FIGS. 5 to 11.

### Uniform Distribution Embodiments

FIG. 5 illustrates where B48 plus more than one band share total power budget. The uniform distribution approach applies to the power distribution method used for dynamic update of the power configuration on bands affected by the change on one of the bands on the multi-band radio. In the following examples, change is triggered on B48 by SAS.

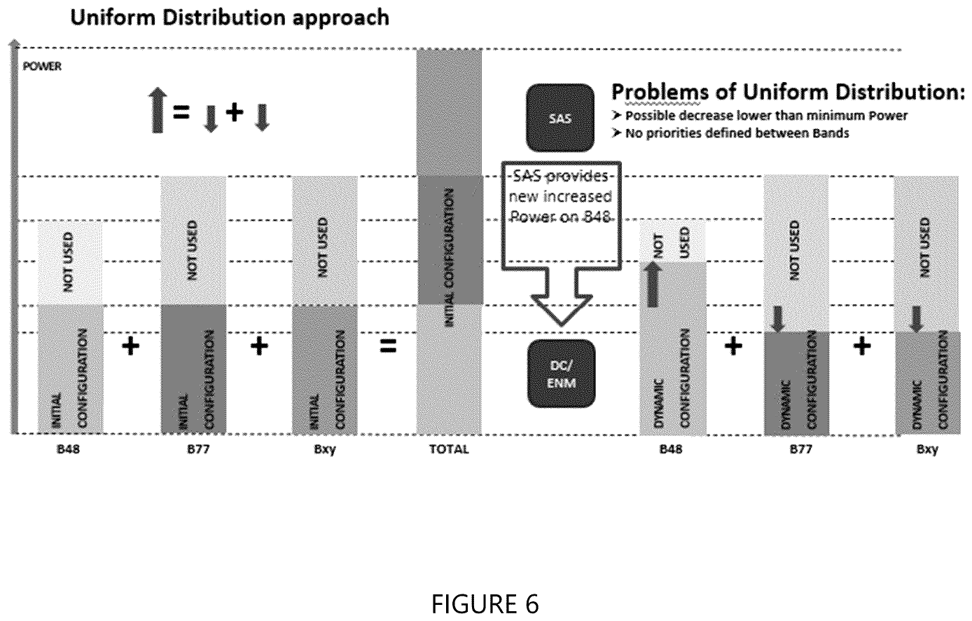

FIG. 6 illustrates where B48 power increase triggers dynamic decrease of other bands power configuration. Uniform distribution approach implies that the increase of power level on one band (in the example above it was B48 Power changed by SAS) corresponds to the power decrease on other bands, where the decrease is evenly distributed between the dynamically adapted power levels on affected bands.

Possible problems that might occur when applying the power decrease on affected bands with the uniform distribution approach include: (a) on certain affected band the power decrease may result in a power level that is lower than the desired minimum level; and/or (b) the decrease in power level is applied to all affected bands evenly, without regard for priorities between bands.

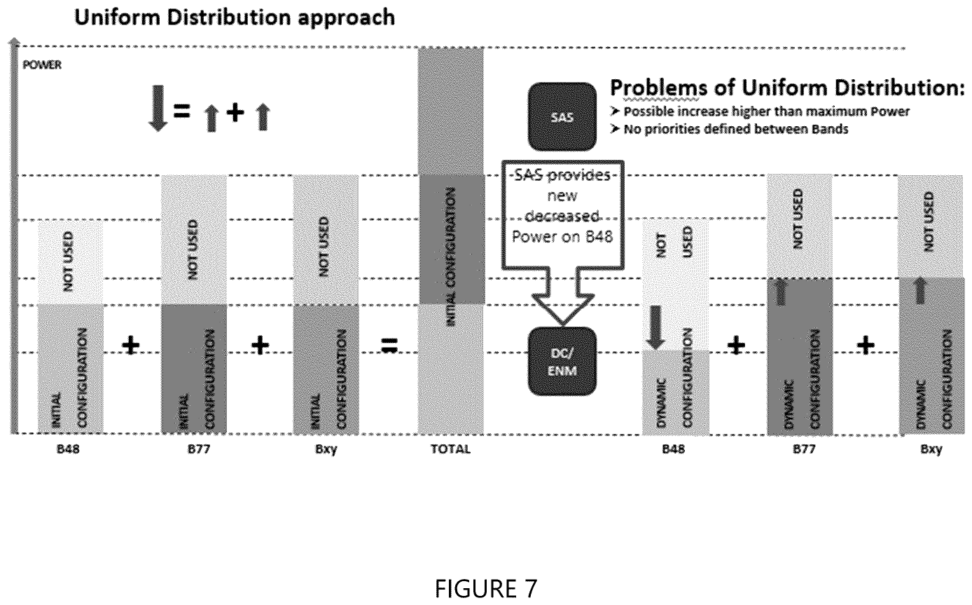

FIG. 7 illustrates an example of uniform distribution of dynamic power increase on affected bands. FIG. 7 illustrates where B48 power decrease triggers dynamic increase of other bands power configuration. The uniform distribution approach implies that the decrease of power level on one band (in the example above it was B48 power changed by SAS) corresponds to the power increase on other bands, where the increase is evenly distributed between the dynamically adapted power levels on affected bands. Possible problems that might occur when applying the power increase on affected bands with the uniform distribution approach are: (a) on certain affected band, the power increase may result in a power level that is higher than the desired maximum level; and/or (b) the increase in power level is applied to all affected bands evenly, without regard for priorities between bands.

To overcome possible problems that may occur when applying uniform distribution of power adaptation (increase or decrease) within the boundaries of total power capability of the multi-band radio, some embodiments define new standardized parameters that enable dynamic power level adjustment with respect to the boundaries of power levels set by operator (minimum and maximum). Similarly, some embodiments define new standardized parameters that enable dynamic power level adjustment with respect to the priorities between bands when applying either power increase or power decrease, after change of power level has been triggered by the change on one of the bands on a multi-band radio.

### Managed Distribution Embodiments

Managed distribution applies to the power distribution method used for dynamic update of the power configuration on bands affected by the change on one of the bands on a multi-band radio. In the following examples, change is triggered on B48 by SAS.

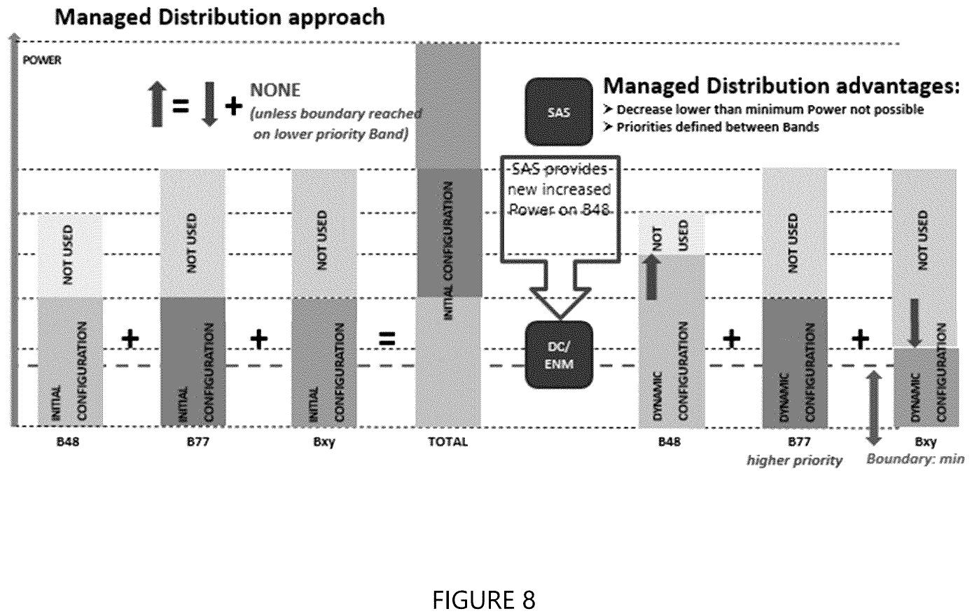

FIG. 8 illustrates an example of managed distribution of dynamic power decrease on affected bands, triggered by the power increase on one of the bands. In the illustrated example, B48 power level is increased by SAS. FIG. 8 illustrates a case with B48 power increase, boundaries and priorities are defined on other bands. In example of FIG. 8, an operator may set new parameters for: (a) priorities on affected bands, in this example higher priority on band B77, and/or (b) lower boundary for power level on bands affected by dynamic power level change.

Using the parameters defined above, dynamic distribution of power is able to satisfy the following objectives: (a) avoid decrease of power below minimum level set by operator, and/or (b) apply prioritized distribution of power according to the operator's policy, i.e. optimization targets.

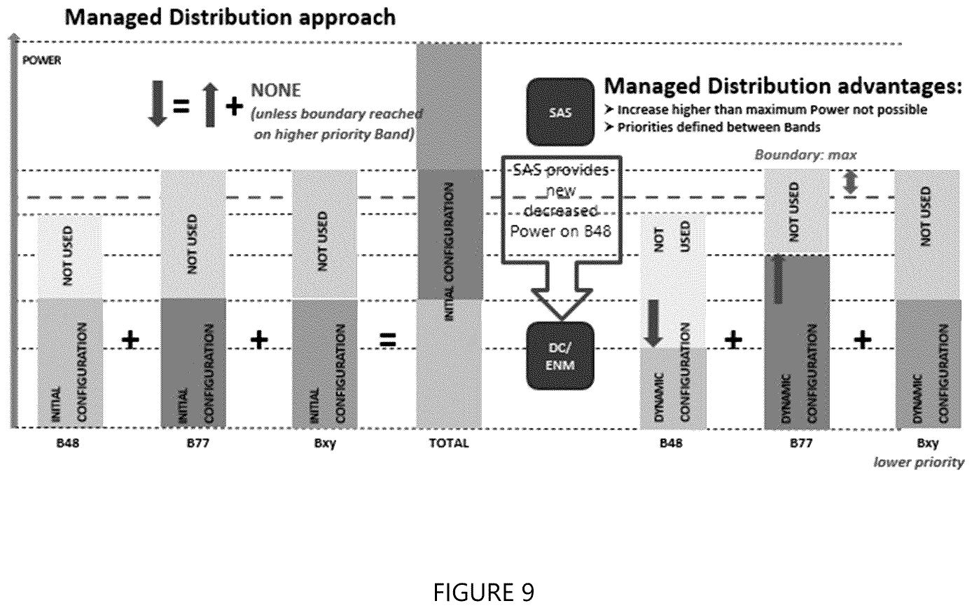

FIG. 9 illustrates an example of managed distribution of dynamic power increase on affected bands, triggered by the power decrease on one of the bands. In this example, B48 power level is decreased by SAS. FIG. 9 illustrates B48 power decrease, boundaries and priorities are defined on other bands. In the example of FIG. 9, the operator may set the following parameters: (a) priorities on affected bands, in this example lower priority on band B77; and/or (b) upper boundary for power level on bands affected by dynamic power level change.

Using the parameters above, dynamic distribution of power is able to satisfy the following objectives: (a) avoid increase of power above maximum level set by operator; and/or (b) apply prioritized distribution of power according to the operator's policy, i.e. optimization targets.

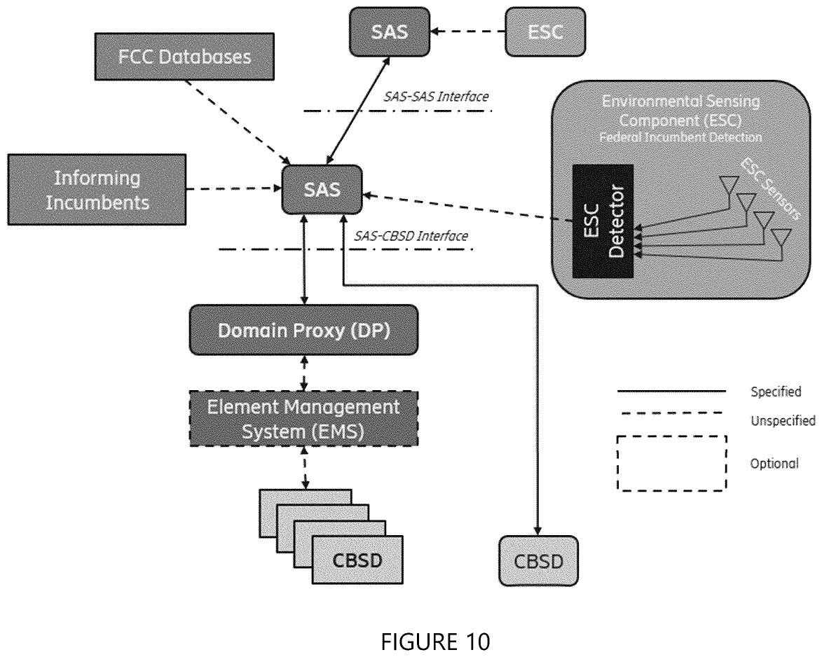

FIG. 10 illustrates an example CBRS architecture, according to certain embodiments. Components of the CBRS illustrated in FIG. 10 are described below.

The Spectrum Access System (SAS) authorizes and manages use of spectrum for the CBRS in accordance with subpart F (see FCC rules). SAS is not under control of network operator, but SAS is an overall CBRS architecture element that is responsible for bandwidth allocation. Therefore, the observability of the results of actions performed by SAS over network operator's CBRS infrastructure is of a special interest for an operator.

The domain proxy is an entity engaging in communications with the SAS on behalf of multiple individual CBSDs or networks of CBSDs. The domain proxy may also provide a translational capability to interface legacy radio equipment in the 3650-3700 MHz band with a SAS to ensure compliance with Part 96 rules.

The CBRS device (CBSD) refers to fixed stations, or networks of such stations, that operate on a priority access or general authorized access basis in the CBRS. For CBSDs which comprise multiple nodes or networks of nodes, CBSD requirements apply to each node even if network management and communication with the SAS is accomplished via a single network interface.

The Element Management System (EMS) may also be referred to also as OSS (Operations Support System).

Particular embodiments provide systems and methods for dynamic power level adaptation on bands of a multi-band radio affected by the change of one of the available bands, either dynamically (in described example by SAS on B48), or statically (by operator).

Particular embodiments include standardized parameters to support dynamic power configuration adjustments on affected bands on a multi-band radio.

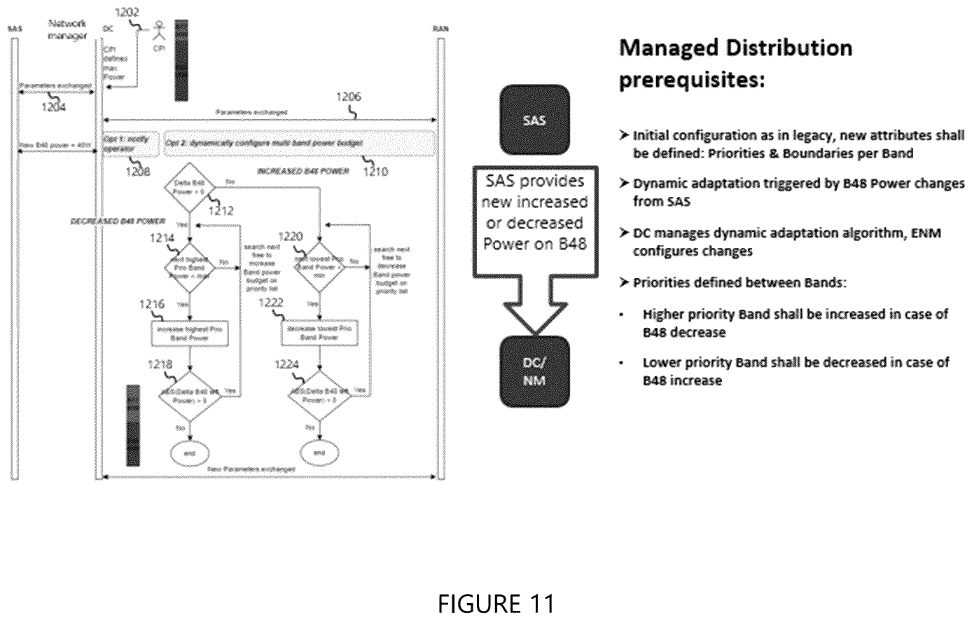

An example method that may be implemented on an element for configuration of power parameters, to support the described solutions, is illustrated in FIG. 11.

FIG. 11 is an example flowchart illustrating a method for distribution of dynamic power configuration at a multi-band radios. The method and the network management system component on which the method is implemented is subject to specific solution and solution provider's specific network architecture implementation. For example, the method provides the new standardized parameters that enable implementation of the method and fulfillment of operator's objectives described herein.

At step 1102, network manager (NM) receives parameters indicating boundaries of power levels (e.g., maximum and minimum threshold power levels) for multi-band radios. For example, a certified professional installer (CPI) may define the power level boundaries. The network manager may be or include a network node, according to certain embodiments described herein. At step 1104, the parameters are exchanged between SAS and network manager. At step 1106, the parameters are exchanged between the network manager and radio access network (RAN). At step 1108, as option 1, an operator is notified, e.g., by the network manager, a network node, or any other entity. At step 1110, as option 2, power budget is dynamically configured at the multi-band radio, e.g., by the network manager or any other entity.

In response, at step 1112, it is determined whether the delta power level at B48 is less than zero. In other words, it is determined whether B48 is experiencing a decrease in power level. If it is determined that the delta power level at B48 is less than zero, the method proceeds to step 1114. Otherwise, the method proceeds to step 1120. At step 1114, it is determined whether the next highest priority band power is less than the maximum boundary. If it is determined that the next highest priority band power is less than the maximum boundary, the highest priority band power level is increased at step 1116. If, however, it is determined that the next highest priority band power more less than the maximum boundary, the method returns to step 1114.

At step 1118, it is determined whether the absolute value of delta power level at B48 is more than zero. If it is determined that the absolute value of delta power level at B48 is more than zero, the method returns to step 1114. Otherwise, the method ends.

At step 1120, it is determined whether the next lowest priority band power level is more than a minimum boundary. If it is determined that the next lowest priority band power level is more than a minimum boundary, the method proceeds to step 1122. Otherwise, the method returns to step 1120.

At step 1122, the lowest priority band power level is decreased. At step 1124, it is determined whether the absolute value of delta power level at B48 is more than zero. If it is determined that the absolute value of delta power level at B48 is more than zero, the method returns to step 1120. Otherwise, the method ends.

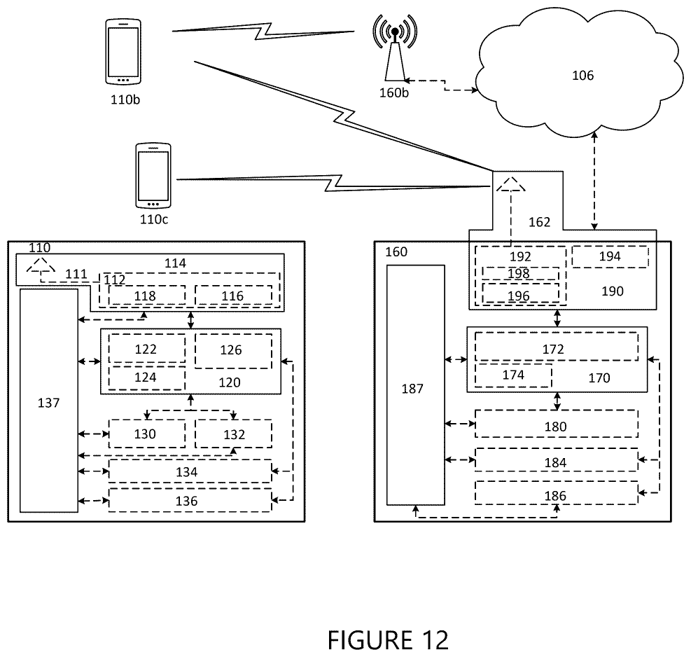

FIG. 12 illustrates an example wireless network, according to certain embodiments. The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network.

Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations.

A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs.

As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 12, network node 160 includes processing circuitry 170, device readable medium 180, interface 190, auxiliary equipment 184, power source 186, power circuitry 187, and antenna 162. Although network node 160 illustrated in the example wireless network of FIG. 12 may represent a device that includes the illustrated combination of hardware components, other embodiments may comprise network nodes with different combinations of components.

It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node.

In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality.

For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signaling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162.

Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHZ and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160.

For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 12 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air.

In some embodiments, a WD may be configured to transmit and/or receive information without direct human interaction. For instance, a WD may be designed to transmit information to a network on a predetermined schedule, when triggered by an internal or external event, or in response to requests from the network.

Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device.

As yet another specific example, in an Internet of Things (IoT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one example, the WD may be a UE implementing the 3GPP narrow band internet of things (NB-IoT) standard. Examples of such machines or devices are sensors, metering devices such as power meters, industrial machinery, or home or personal appliances (e.g. refrigerators, televisions, etc.) personal wearables (e.g., watches, fitness trackers, etc.).

In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114.

Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips.

In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner.

In any of those embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected).

User interface equipment 132 may include input interfaces, devices and circuits, and output interfaces, devices and circuits. User interface equipment 132 is configured to allow input of information into WD 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry.

Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

Although the subject matter described herein may be implemented in any appropriate type of system using any suitable components, the embodiments disclosed herein are described in relation to a wireless network, such as the example wireless network illustrated in FIG. 12. For simplicity, the wireless network of FIG. 12 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

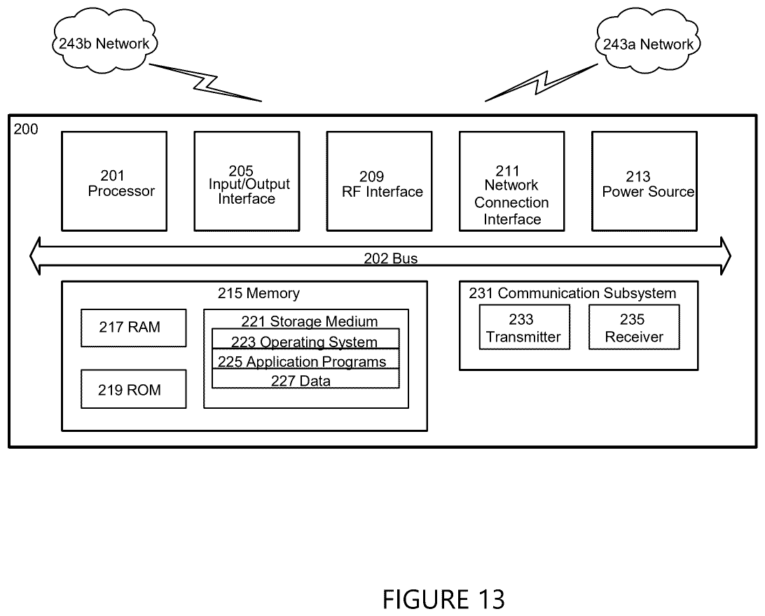

FIG. 13 illustrates an example user equipment, according to certain embodiments. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 13, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 13 is a UE, the components discussed herein are equally applicable to a WD, and vice-versa.

In FIG. 13, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 213, and/or any other component, or any combination thereof. Storage medium 221 includes operating system 223, application program 225, and data 227. In other embodiments, storage medium 221 may include other similar types of information. Certain UEs may use all the components shown in FIG. 13, or only a subset of the components. The level of integration between the components may vary from one UE to another UE. Further, certain UEs may contain multiple instances of a component, such as multiple processors, memories, transceivers, transmitters, receivers, etc.

In FIG. 13, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205.

An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof.

UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 13, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory.

Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 13, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

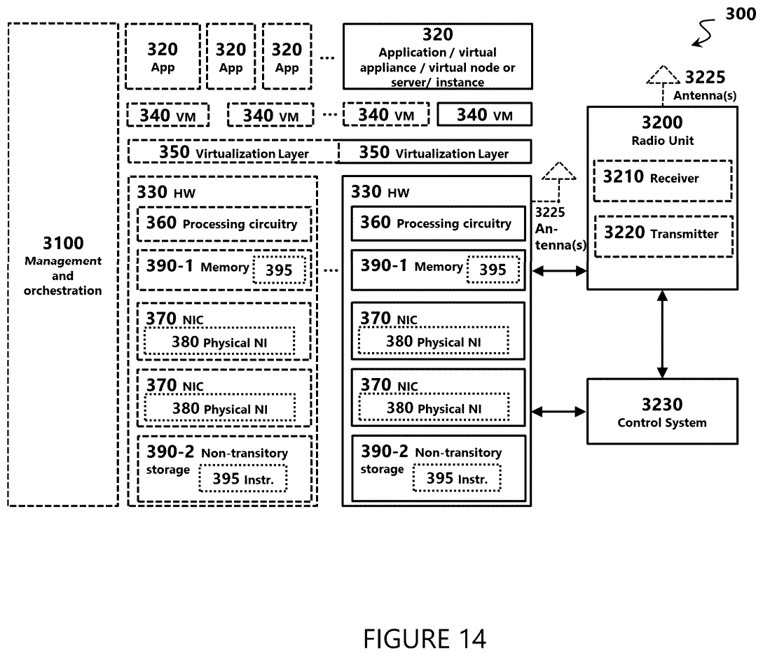

FIG. 14 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 14, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high-volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 14.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be affected with the use of control system 3230 which may alternatively be used for communication between the hardware nodes 330 and radio units 3200.

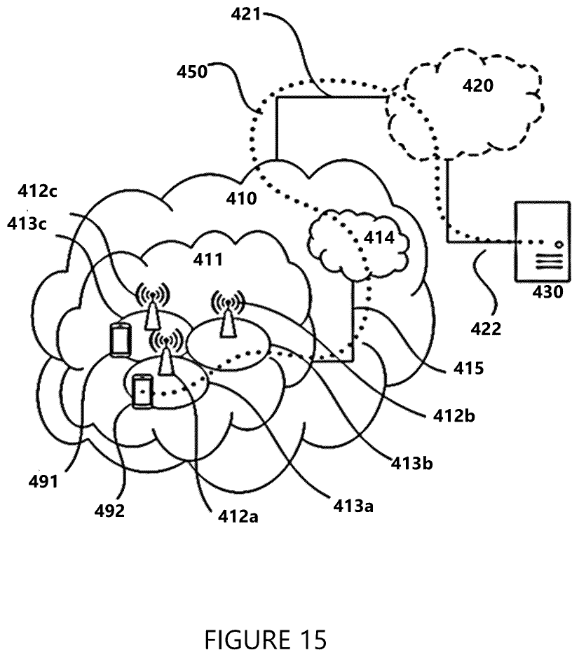

With reference to FIG. 15, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 15 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

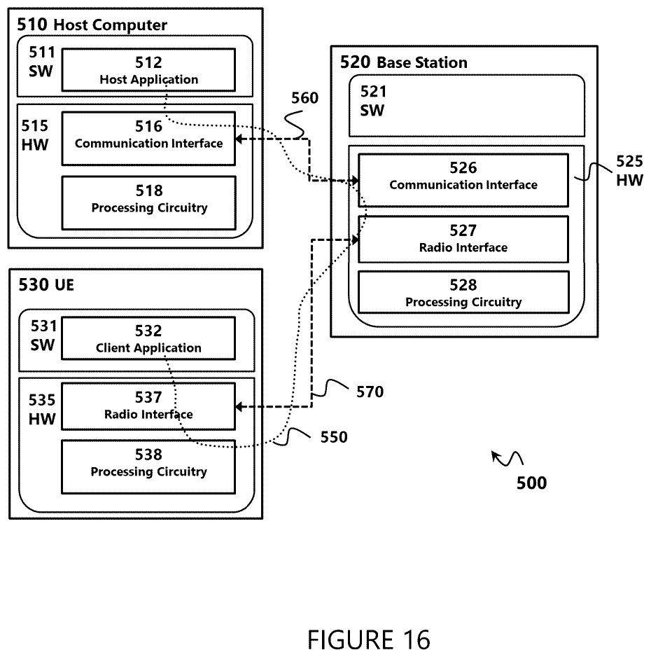

FIG. 16 illustrates an example host computer communicating via a base station with a user equipment over a partially wireless connection, according to certain embodiments. Example implementations, in accordance with an embodiment of the UE, base station and host computer discussed in the preceding paragraphs will now be described with reference to FIG. 16. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 16) served by base station 520. Communication interface 526 may be configured to facilitate connection 560 to host computer 510. Connection 560 may be direct, or it may pass through a core network (not shown in FIG. 16) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 16 may be similar or identical to host computer 430, one of base stations 412a, 412b, 412c and one of UEs 491, 492 of FIG. 20, respectively. This is to say, the inner workings of these entities may be as shown in FIG. 16 and independently, the surrounding network topology may be that of FIG. 20.

In FIG. 16, OTT connection 550 has been drawn abstractly to illustrate the communication between host computer 510 and UE 530 via base station 520, without explicit reference to any intermediary devices and the precise routing of messages via these devices. The network infrastructure may determine the routing, which may be configured to hide from UE 530 or from the service provider operating host computer 510, or both. While OTT connection 550 is active, the network infrastructure may further take decisions by which it dynamically changes the routing (e.g., based on load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the signaling overhead and reduce latency, which may provide faster internet access for users.

A measurement procedure may be provided for monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 cause messages to be transmitted, in particular empty or ‘dummy’ messages, using OTT connection 550 while it monitors propagation times, errors etc.

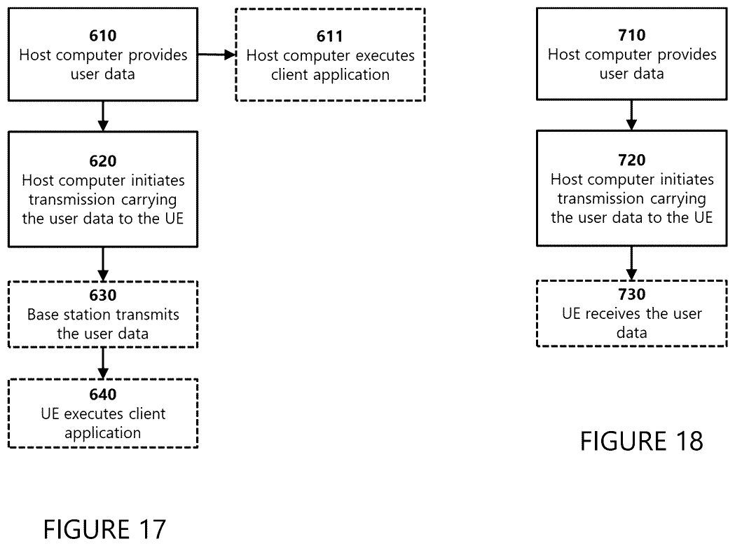

FIG. 17 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 17 will be included in this section.

In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 18 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 18 will be included in this section.

In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

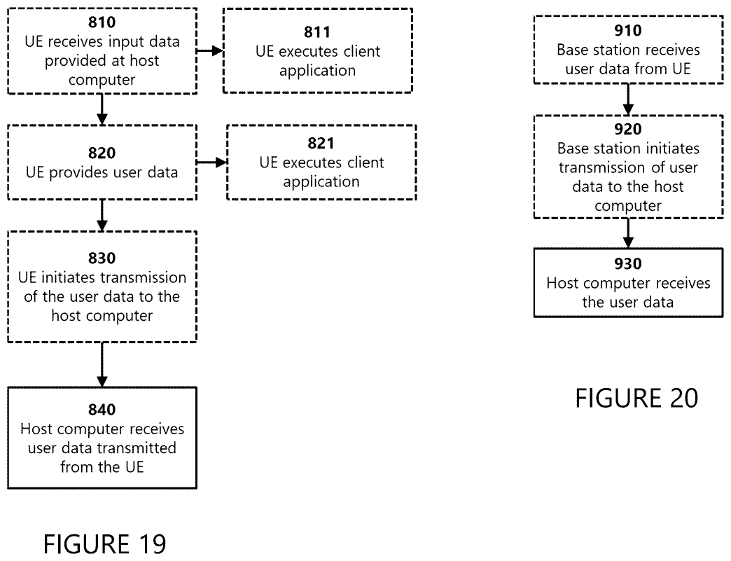

FIG. 19 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 19 will be included in this section.

In step 810 (which may be optional), the UE receives input data provided by the host computer. Additionally, or alternatively, in step 820, the UE provides user data. In substep 821 (which may be optional) of step 820, the UE provides the user data by executing a client application. In substep 811 (which may be optional) of step 810, the UE executes a client application that provides the user data in reaction to the received input data provided by the host computer. In providing the user data, the executed client application may further consider user input received from the user. Regardless of the specific manner in which the user data was provided, the UE initiates, in substep 830 (which may be optional), the transmission of the user data to the host computer. In step 840 of the method, the host computer receives the user data transmitted from the UE, in accordance with the teachings of the embodiments described throughout this disclosure.

FIG. 20 is a flowchart illustrating a method implemented in a communication system, in accordance with one embodiment. The communication system includes a host computer, a base station, and a UE which may be those described with reference to FIGS. 15 and 16. For simplicity of the present disclosure, only drawing references to FIG. 20 will be included in this section.

In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

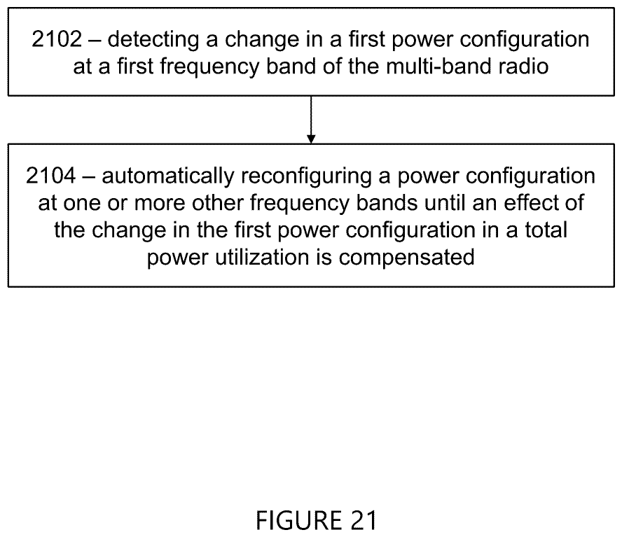

FIG. 21 illustrates an example flow diagram for a method 2100 for according to one or more embodiments of the present disclosure. In particular embodiments, one or more steps of method 2100 may be performed network node 160 described with respect to FIG. 12.

The method 2100 may begin at step 2102, where the network node (.e. g, network node 160 or any other suitable network node) detects a change in a first power configuration at a first frequency band of the multi-band radio. In particular embodiments, the change is a power increase in the first power configuration. In particular embodiments, the change is a power decrease in the first power configuration.

At step 2104, the network node automatically reconfigures a power configuration at one or more other frequency bands until an effect of the change in the first power configuration in a total power utilization is compensated.

In particular embodiments, when the change is a power increase in the first power configuration, automatically reconfiguring the power configuration at the one or more other frequency bands comprises decreasing a second power configuration at the one or more other frequency bands. In particular embodiments, the decrease in the second power configuration is evenly distributed between the one or more other frequency bands.

In particular embodiments, when the change is a power decrease in the first power configuration, and automatically reconfiguring the power configuration at the one or more other frequency bands comprises increasing a second power configuration at the one or more other frequency bands. In particular embodiments, the increase in the second power configuration is evenly distributed between the one or more other frequency bands.

In particular embodiments, automatically reconfiguring the power configuration at the one or more other frequency bands is according to a set of parameters. The set of parameters may comprise a first parameter that indicates adjusting power levels at the one or more other frequency bands should not exceed a minimum boundary according to any of the embodiments and examples described herein. The set of parameters may further comprise a second parameter that indicates adjusting power levels at the one or more other frequency bands should not exceed a maximum boundary according to any of the embodiments and examples described herein. The set of parameters may further indicate a priority for each of the one or more other frequency bands, such that less power level decrease is applied to a frequency band with a high priority according to any of the embodiments and examples described herein.

In particular embodiments, the first frequency band is controlled by a first operating entity and the one or more other frequency bands are controlled by a second operating entity. In particular embodiments, the first operating entity comprises a spectrum access system (SAS). In particular embodiments, detecting the change in the first power configuration at the first frequency band comprises receiving a grant from the SAS with a changed power value. In particular embodiments, the first operating entity comprises a network operator. In particular embodiments, detecting the change in the first power configuration at the first frequency band comprises detecting a manual power reconfiguration.

Modifications, additions, or omissions may be made to the method of FIG. 21. Additionally, one or more steps in the method of FIG. 21 may be performed in parallel or in any suitable order.

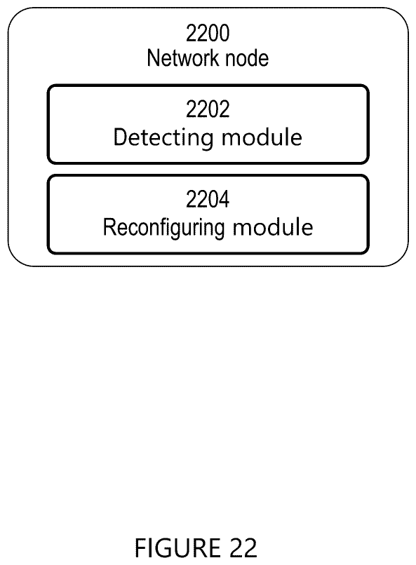

FIG. 22 illustrates a schematic block diagram of an apparatus in a wireless network (for example, the wireless network illustrated in FIG. 12). The apparatus may include a network node (e.g., network node 160 illustrated in FIG. 12). Apparatus 2200 is operable to carry out the example methods described with reference to FIGS. 1-21 and possibly any other processes or methods disclosed herein. It is also to be understood that the method of FIG. 21 is not necessarily carried out solely by apparatus 2200. At least some operations of the method may be performed by one or more other entities.

Virtual apparatus 2200 may comprise processing circuitry, which may include one or more microprocessors or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments.

In some implementations, the processing circuitry may be used to cause detecting module 2202 and reconfiguring module 2204, and any other suitable units of apparatus 2200 to perform corresponding functions according to one or more embodiments of the present disclosure.

As illustrated in FIG. 22, apparatus 2200 includes detecting module 2202 configured to detect a change in a first power configuration at a first frequency band of the multi-band radio according to any of the embodiments and examples described herein. Reconfiguring module 2204 is configured to automatically reconfigure a power configuration at one or more other frequency bands until an effect of the change in the first power configuration in a total power utilization is compensated according to any of the embodiments and examples described herein.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

### Abbreviation Explanation

Citizens Broadband Radio Service Device (CBSD): Fixed Stations, or networks of such stations, that operate on a Priority Access or General Authorized Access basis in the Citizens Broadband Radio Service consistent with Title 47 CFR Part 96 [n.8]. For CBSDs that comprise multiple nodes or networks of nodes, CBSD requirements apply to each node even if network management and communication with the SAS is accomplished via a single network interface [Source: WINNF-TS-0016 SAS to CBSD Technical Specification v1.1.0] A CBSD is a transmission point. Some CBSD may include distributed antenna systems that include a single radio connected to many scattered antennas and each antenna may be handled as a separate CBSD.
CBSD Antenna: The radiating element(s) of the CBSD. Each CBSD has one CBSD Antenna. Note that the CBSD's antenna may be instantiated with multiple physical antennas (e.g., an antenna array for MIMO operation), but those antennas must be transmitting one aggregate waveform collectively from a single geolocation, and with a total transmit power that conforms to all the CBSD's registration parameters and authorized transmit power levels provided by the SAS in its active Grants (e.g., maximum allowable EIRP). [Source: WINNF-TS-0016 SAS to CBSD Technical Specification v1.1.0]
Domain Proxy: An entity engaging in communications with the SAS on behalf of multiple individual CBSDs or networks of CBSDs. The Domain Proxy can also provide a translational capability to interface legacy radio equipment in the 3650-3700 MHz band with a SAS to ensure compliance with Part 96 rules [n.8]. [Source: WINNF-TS-0016 SAS to CBSD Technical Specification v1.1.0]
End User Device. A device authorized and controlled by an authorized CBSD. These devices may not be used as intermediate service links or to provide service over the frequencies listed in section 96.11 to other End User Devices or CBSDs. [Source: FCC rules]
Environmental Sensing Capability (ESC): A system that detects and communicates the presence of a signal from an Incumbent User to an SAS to facilitate shared spectrum access consistent with sections 96.15 and 96.67. [Source: FCC rules]
Grant: The authorization provided by a SAS to a CBSD, subject to a Heartbeat exchange, to transmit using specified operating parameters. Grants are identified by a unique Grant identifier. Once issued, a Grant's operating parameters are never changed; if new or modified operating parameters are required, then a new Grant must be obtained. The Grant's operating parameters are maximum EIRP and Channel. A Grant can be in different states as defined in section 7. [Source: WINNF-TS-0016 SAS to CBSD Technical Specification v1.1.0]
Spectrum Access System (SAS): A system that authorizes and manages use of spectrum for the Citizens Broadband Radio Service in accordance with subpart F. [Source: FCC rules]
Managing SAS: The SAS that serves a Registered Owner of a PAL and serves the CBSDs on the Registered Owner's PPA's Cluster List or serves the CBSDs on a valid lessee's PPA's Cluster List. This Managing SAS is the SAS which accepts, checks, and validates a PPA claim and which issues a PPA-ID for a valid PPA, and which shares the PPA-ID and the PPA vertex points with all SASs. Subsequently, the Managing SAS serves the CBSDs on the PPA's Cluster List. [Source: WINNF-TS-0112 CBRS Operational and Functional Requirements v1.2.0]
PAL reserved channel: A 10 MHz channel in the range of 3550-3650 that a SAS may establish for exclusive use of a set of one or more CBSDs that are registered as belonging to a PPA based upon acquired PAL rights. [Source: FCC rules]

1. A method performed by a network node having a multi-band radio for dynamic power sharing, the method comprising:
detecting a change in a first power configuration at a first frequency band of the multi-band radio; and
automatically reconfiguring a power configuration at one or more other frequency bands until an effect of the change in the first power configuration in a total power utilization is compensated.

2. The method of claim 1, wherein the change is a power increase in the first power configuration, and automatically reconfiguring the power configuration at the one or more other frequency bands comprises decreasing a second power configuration at the one or more other frequency bands.

3. The method of claim 2, wherein the decrease in the second power configuration is evenly distributed between the one or more other frequency bands.

4. The method of claim 1, wherein the change is a power decrease in the first power configuration, and automatically reconfiguring the power configuration at the one or more other frequency bands comprises increasing a second power configuration at the one or more other frequency bands.

5. The method of claim 4, wherein the increase in the second power configuration is evenly distributed between the one or more other frequency bands.

6. The method of claim 1, wherein automatically reconfiguring the power configuration at the one or more other frequency bands is according to a set of parameters,
the set of parameters comprises a first parameter that indicates adjusting power levels at the one or more other frequency bands should not exceed a minimum boundary, and
the set of parameters further comprises a second parameter that indicates adjusting power levels at the one or more other frequency bands should not exceed a maximum boundary.

7. The method of claim 6, wherein the set of parameters further indicates a priority for each of the one or more other frequency bands, such that less or no power level decrease is applied to a frequency band with a high priority.

8. The method of claim 1, wherein the first frequency band is controlled by a first operating entity and the one or more other frequency bands are controlled by a second operating entity.

9. The method of claim 8, wherein the first operating entity comprises a spectrum access system (SAS).

10. The method of claim 9, wherein detecting the change in the first power configuration at the first frequency band comprises receiving a grant from the SAS with a changed power value.

11. The method of claim 8, wherein the first operating entity comprises a network operator.

12. The method of claim 11, wherein detecting the change in the first power configuration at the first frequency band comprises detecting a manual power reconfiguration.

13. A network node having a multi-band radio and capable of dynamic power sharing, the network node comprising processing circuitry operable to:
detect a change in a first power configuration at a first frequency band of the multi-band radio; and
automatically reconfigure a power configuration at one or more other frequency bands until an effect of the change in the first power configuration in a total power utilization is compensated.

14. The network node of claim 13, wherein the change is a power increase in the first power configuration, and the processing circuitry is operable to automatically reconfigure the power configuration at the one or more other frequency bands by decreasing a second power configuration at the one or more other frequency bands.

15. The network node of claim 14, wherein the decrease in the second power configuration is evenly distributed between the one or more other frequency bands.

16. The network node of claim 13, wherein the change is a power decrease in the first power configuration, and the processing circuitry is operable to automatically reconfigure the power configuration at the one or more other frequency bands by increasing a second power configuration at the one or more other frequency bands.

17. The network node of claim 16, wherein the increase in the second power configuration is evenly distributed between the one or more other frequency bands.

18. The network node of claim 13, wherein the processing circuitry is operable to automatically reconfigure the power configuration at the one or more other frequency bands according to a set of parameters,
the set of parameters comprises a first parameter that indicates adjusting power levels at the one or more other frequency bands should not exceed a minimum boundary, and
the set of parameters further comprises a second parameter that indicates adjusting power levels at the one or more other frequency bands should not exceed a maximum boundary.

19. The network node of claim 18, wherein the set of parameters further indicates a priority for each of the one or more other frequency bands, such that less or no power level decrease is applied to a frequency band with a high priority.

20. The network node of claim 13, wherein the first frequency band is controlled by a first operating entity and the one or more other frequency bands are controlled by a second operating entity.

21.-24. (canceled)
